(19) United States
(12) Patent Application Publication
(10) Pub. No.: US 2024/0249213 A1
(43) Pub. Date: Jul. 25, 2024

(54) METHOD AND SYSTEM FOR AUTOMATICALLY ASSIGNING ONE OR MORE TASKS TO ONE OR MORE USERS

(71) Applicant: JPMorgan Chase Bank, N.A., New York, NY (US)

(72) Inventor: Ashish AGRAWAL, Hyderabad (IN)

(73) Assignee: JPMorgan Chase Bank, N.A., New York, NY (US)

(21) Appl. No.: 18/118,527

(22) Filed: Mar. 7, 2023

(30) Foreign Application Priority Data
Jan. 23, 2023 (IN) 202311004491

(51) Int. Cl. G06Q 10/0631

(52) U.S. Cl. CPC G06Q 10/063112

(57) ABSTRACT

A method for automatically assigning one or more tasks to one or more users. The method includes receiving, by at least one processor via a communication interface, one or more tasks; dynamically maintaining, by the at least one processor, a primary queue for the one or more tasks received at the at least one processor; determining, by the at least one processor, a weightage for each of the one or more tasks; analysing, by the at least one processor, a skill matrix of the one or more users based on the weightage determined for the one or more tasks; identifying, by the at least one processor, the one or more users for assignment of the one or more tasks based on the analysis; and automatically assigning, by the at least one processor, the one or more tasks to the one or more identified users.

### CROSS-REFERENCE TO RELATED APPLICATIONS

This application claims the benefit of priority from Indian Patent Application No. 202311004491, filed Jan. 23, 2023, which is herein incorporated by reference in its entirety.

### FIELD OF THE DISCLOSURE

This technology generally relates to methods and systems for automatically assigning task(s) to user(s), and more particularly to methods and systems for dynamically allotting/assigning task(s) to a user(s) based on the weightage of the task and the skill of the user.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Efficient use and management of resources, including professionals and support staff, and engagements, is critical for effective and efficient delivery of services and work products, particularly in large organisations such as professional services entities including banking organizations. Adequate tracking of performance, expertise, credentials, experience, qualification, client or task familiarity, and other work-related information is a longstanding need. Products for tracking discrete aspects of employees and engagement information, such as dynamic allotment of work as per experience and credentials of the employee, play an important role in streamlining the process. Yet, the current solutions for allotment of work within the organization though well known only provides limited functionality.

Modern banking institutions handle numerous new customers on a daily basis. In addition to the banking services, there are many departments and teams of support staff, such as employees that handle Know-your-customer (KYC) requests to support onboarding process of the customers with the bank and they must ensure that the onboarding process is seamless and effortless. Orchestrating the activities of distinct departments in a banking institution is a tremendous feat of organisation and communication, and inefficiencies often result from miscommunication and insufficient task tracking. Periodic review of the accounts is another peculiar feature of the banking industry that lacks efficiency.

Current systems rely on manually generating task requests and sending it to the employees to complete the task. Also, the periodic review for the cases is assigned on a first come first serve based on the renewal timelines, which also often leads to delaying the completion of the lengthy task requests, with the tasks being either delayed to the end day or the deadline being missed. For instance, often times both the KYC reviewer and the requester would not know if or when the task was completed or whether a qualified employee completed the task. This results in delayed outcomes, dissatisfaction, redundant communications, poor visibility into service request progress, longer wait times, and unfinished requests, among other problems. In view of the deficiencies of the current systems, improved systems and methods for performing automatic real-time task scheduling and tracking are desired.

Hence, in view of these and other existing limitations, there arises an imperative need to provide an efficient solution to overcome the above-mentioned limitations and to provide an approach that can overcome above-mentioned limitations by automatic assignment of task(s) relating to request for authentication of identity to user(s) (e.g., employed handling KYC requests).

### SUMMARY

The present disclosure, through one or more of its various aspects, embodiments, and/or specific features or sub-components, provides, inter alia, various systems, servers, devices, methods, media, programs, and platforms for automatically assigning task(s) to user(s).

According to an aspect of the present disclosure, method for automatically assigning one or more tasks to one or more users is disclosed. The method is implemented by at least one processor. The method may include receiving, by the at least one processor via a communication interface, one or more tasks; dynamically maintaining, by the at least one processor, a primary queue for the one or more tasks received at the at least one processor, determining, by the at least one processor, a weightage for each of the one or more tasks, analysing, by the at least one processor, a skill matrix of the one or more users based on the weightage determined for the one or more tasks, identifying, by the at least one processor, the one or more users for assignment of the one or more tasks based on the analysis, and automatically assigning, by the at least one processor, the one or more tasks to the one or more identified users.

In accordance with an exemplary embodiment, skill matrix for the one or more users is based on at least one of a number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type associated with the one or more tasks handled by the one or more users.

In accordance with an exemplary embodiment, the weightage is determined for each of the one or more tasks based on at least one of an expected time for completion of the one or more tasks, an organization type associated with the one or more tasks, an urgency associated with the one or more tasks, a type of request associated with the one or more, and a due diligence condition associated with the one or more tasks.

In accordance with an exemplary embodiment, the method of automatically assigning the one or more tasks to the one or more identified users further comprises assigning the one or more tasks to at least one first user and at least one second user based on the due diligence condition associated with the one or more tasks and the region handled by the at least one first user and the at least one second user.

In accordance with an exemplary embodiment, the method further comprises identifying the one or more users based on an availability of the one or more users.

In accordance with an exemplary embodiment, wherein modification in the availability of the one or more users, the method further comprises automatically identifying another user from the one or more users based on the analysis of the skill matrix of the one or more users.

In accordance with an exemplary embodiment, the method further comprises maintaining a secondary queue for each of the one or more users, wherein the secondary queue for each of the one or more users comprises of the one or more tasks assigned to the one or more users.

In accordance with an exemplary embodiment, the method further comprises identifying the one or more users based on a threshold of the one or more users, wherein the threshold of the one or more users is determined based on the skill matrix.

In accordance with an exemplary embodiment, the one or more tasks relate to request for authentication of identity.

In accordance with an exemplary embodiment, the method further comprising notifying the one or more users of the assignment of the one or more tasks to the one or more users.

According to an aspect of the present disclosure, a computing device for automatically assigning one or more tasks to one or more users. The computing device comprises a processor, a memory, and a communication interface coupled to each of the processor and the memory, wherein the processor may be configured to receive the one or more tasks; dynamically maintain a primary queue for the one or more tasks received at the processor; determine a weightage for each of the one or more tasks; analyse a skill matrix of the one or more users based on the weightage determined for the one or more tasks; identify the one or more users for assignment of the one or more tasks based on the analysis; and automatically assign the one or more tasks to the one or more identified users.

In accordance with an exemplary embodiment, the skill matrix for the one or more users is based on at least one of a number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type associated with the one or more tasks handled by the one or more users.

In accordance with an exemplary embodiment, the processer is further configured to determine the weightage for each of the one or more tasks based on at least one of an expected time for completion of the one or more tasks, an organization type associated with the one or more tasks, an urgency associated with the one or more tasks, a type of request associated with the one or more, and a due diligence condition associated with the one or more tasks.

In accordance with an exemplary embodiment, the processer is further configured to automatically assign the one or more tasks to at least one first user and at least one second user based on the due diligence condition associated with the one or more tasks and the region handled by the at least one first user and the at least one second user.

In accordance with an exemplary embodiment, the processor is further configured to identify the one or more users based on an availability of the one or more users.

In accordance with an exemplary embodiment, modification in the availability of the one or more users, the processer is further configured to automatically identify another user from the one or more users based on the analysis of the skill matrix of the one or more users.

In accordance with an exemplary embodiment, the processer is further configured to maintain a secondary queue for each of the one or more users, wherein the secondary queue for each of the one or more users comprises of the one or more tasks assigned to the one or more users, wherein the one or more tasks relate to request for authentication of identity.

In accordance with an exemplary embodiment, the processer is further configured to notify the one or more users of the assignment of the one or more tasks to the one or more users.

In accordance with an exemplary embodiment, the processer is further configured to identify the one or more users based on a threshold of the one or more users, wherein the threshold of the one or more users is determined based on the skill matrix.

In accordance with an exemplary embodiment, the one or more tasks relate to request for authentication of identity.

According to an aspect of the present disclosure, a non-transitory computer readable storage medium storing instruction for automatically assigning one or more tasks to one or more users. The storage medium comprising executable code which, when executed by a processor, may cause processor to receive the one or more tasks; dynamically maintain a primary queue for the one or more tasks received at the processor; determine a weightage for each of the one or more tasks; analyse a skill matrix of the one or more users based on the weightage determined for the one or more tasks; identify the one or more users for assignment of the one or more tasks based on the analysis; and automatically assign the one or more tasks to the one or more identified users.

In accordance with an exemplary embodiment, the skill matrix for the one or more users is based on at least one of a number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type associated with the one or more tasks handled by the one or more users.

In accordance with an exemplary embodiment, the storage medium comprising executable code which, when executed by the processor, further causes the processor to determine the weightage for each of the one or more tasks based on at least one of an expected time for completion of the one or more tasks, an organization type associated with the one or more tasks, an urgency associated with the one or more tasks, a type of request associated with the one or more, and a due diligence condition associated with the one or more tasks.

In accordance with an exemplary embodiment, the storage medium comprising executable code which, when executed by the processor, further causes the processor to automatically assign the one or more tasks to at least one first user and at least one second user based on the due diligence condition associated with the one or more tasks and the region handled by the at least one first user and the at least one second user.

In accordance with an exemplary embodiment, the storage medium comprising executable code which, when executed by the processor, further causes the processor to identify the one or more users based on an availability of the one or more users.

In accordance with an exemplary embodiment, wherein modification in the availability of the one or more users, the storage medium comprising executable code which, when executed by the processor, further causes the processor to automatically identify another user from the one or more users based on the analysis of the skill matrix the one or more users.

In accordance with an exemplary embodiment, the storage medium comprising executable code which, when executed by the processor, further causes the processor to maintain a secondary queue for each of the one or more users, wherein the secondary queue for each of the one or more users comprises of the one or more tasks assigned to the one or more users.

In accordance with an exemplary embodiment, the storage medium comprising executable code which, when executed by the processor, further causes the processor to notify the one or more users of the assignment of the one or more tasks to the one or more users.

In accordance with an exemplary embodiment, the storage medium comprising executable code which, when executed by the processor, further causes the processor to identify the one or more users based on a threshold of the one or more users, wherein the threshold of the one or more users is determined based on the skill matrix.

In accordance with an exemplary embodiment, the one or more tasks relate to request for authentication of identity.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary computer system.

FIG. 2 illustrates an exemplary diagram of a network environment.

FIG. 3 shows an exemplary system diagram for implementing a method for automatically assigning one or more tasks to one or more users, in accordance with exemplary embodiment of the present disclosure.

FIG. 4 illustrates an exemplary method flow diagram for automatically assigning one or more tasks to one or more users, in accordance with exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. Also, as used herein, the phrase “at least one” means and includes “one or more” and such phrases/terms can be used interchangeably. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

In addition, all logical units/controller described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the invention. It will be apparent however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

To overcome the problems associated with matching an employee's capability with the needs mandated by the task. The present disclosure provides a method and a system for automatically assigning task(s) to user(s). The system receives, one or more tasks from one or more sources, and generates a primary queue for the one or more tasks. A weightage is assigned to each of the one or more tasks based on parameters including complexity of the task, the regulation of the industry, applicable deadlines, amount of work, etc. A skill matrix is created for one or more users (e.g., employees, etc.) with available information such as past experience, industrial experience, professional credentials, expertise, office practice groups, etc. Finally, the skill matrix for the user(s) is analysed and the complexity and nature of the task are compared to the user's ability, usefulness, capabilities, seniority, and skill set. The task is accordingly assigned to the user(s) which are available and qualified and thus best suited to the needs mandated by the task. The method and the system also takes into consideration user's availability in real time and is capable of assigning the task to another user in real time where the first assigned user may not be available for reasons including scheduled vacation time, scheduled continuing education courses, meetings, projects, or other tasks.

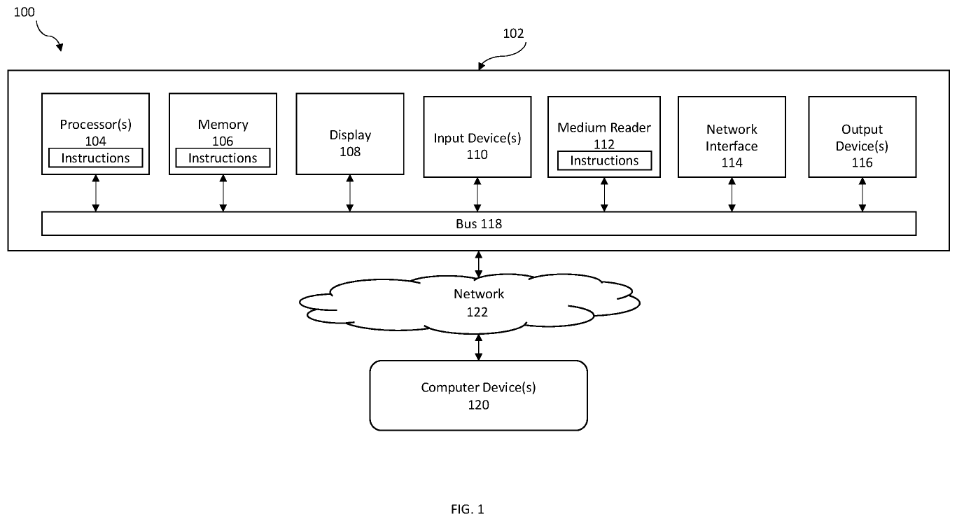

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As used herein, a skill matrix is a record maintained for the one or more users comprising at least one of a number of the one or more tasks handled by the one or more users, a number of the tasks completed by the one or more users, a skill level of the one or more users, a region associated with the one or more tasks handled by the one or more users, a risk associated with the one or more tasks handled by the one or more users, and an organization type associated with the one or more tasks handled by the one or more users.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central at least one processor (CPU), a graphics at least one processor (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present invention, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically assigning one or more tasks to the one or more users.

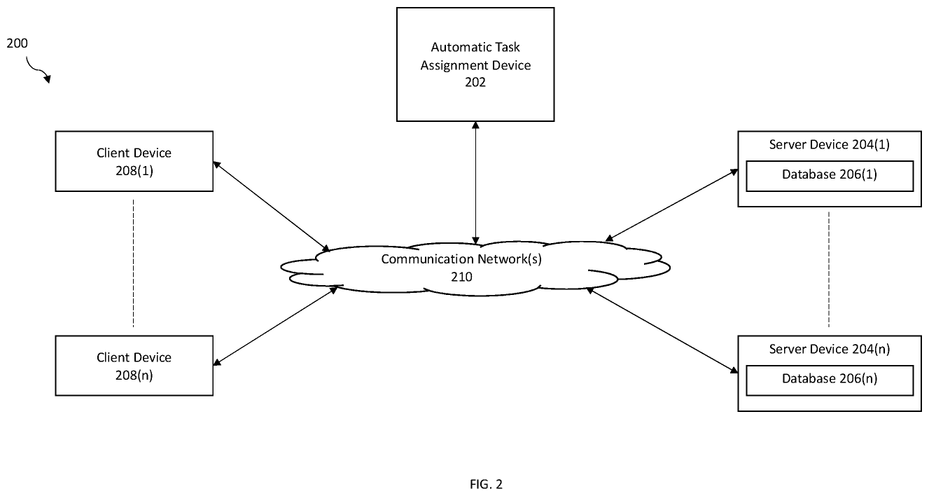

Referring to FIG. 2, a schematic of an exemplary network environment 200 for implementing a method for automatically assigning one or more tasks to one or more users is illustrated. In an exemplary embodiment, the method is executable on any networked computer platform, such as, for example, a personal computer (PC).

The method for automatically assigning one or more tasks to one or more users may be implemented by an Automatic Task Assignment (ATA) device 202. The ATA device 202 may be the same or similar to the computer system 102 as described with respect to FIG. 1. The ATA device 202 may store one or more applications that can include executable instructions that, when executed by the ATA device 202, cause the ATA device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as virtual machine(s) or virtual server(s) that may be managed in a cloud-based computing environment. Also, the application(s), and even the ATA device 202 itself, may be located in virtual server(s) running in a cloud-based computing environment rather than being tied to one or more specific physical network computing devices. Also, the application(s) may be running in one or more virtual machines (VMs) executing on the ATA device 202. Additionally, in one or more embodiments of this technology, virtual machine(s) running on the ATA device 202 may be managed or supervised by a hypervisor.

In the network environment 200 of FIG. 2, the ATA device 202 is coupled to a plurality of server devices 204(1)-204(n) that hosts a plurality of databases 206(1)-206(n), and also to a plurality of client devices 208(1)-208(n) via communication network(s) 210. A communication interface of the ATA device 202, such as the network interface 114 of the computer system 102 of FIG. 1, operatively couples and communicates between the ATA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ATA devices that efficiently implement a method for automatically assigning one or more tasks for one or more users.

By way of example only, the communication network(s) 210 may include local area network(s) (LAN(s)) or wide area network(s)(WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), Public Switched Telephone Network (PSTNs), Ethernet-based Packet Data Networks (PDNs), combinations thereof, and the like.

The ATA device 202 may be a standalone device or integrated with one or more other devices or apparatuses, such as one or more of the server devices 204(1)-204(n), for example. In one particular example, the ATA device 202 may include or be hosted by one of the server devices 204(1)-204(n), and other arrangements are also possible. Moreover, one or more of the devices of the ATA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the ATA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to one or more users (e.g., employees), number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type (e.g., client) associated with the one or more tasks handled by the one or more users, software programs, machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ATA device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ATA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ATA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ATA device 202, the server devices 204(1)-204(n), or the client devices 208(1)-208(n), for example, may be configured to operate as virtual instances on the same physical machine. In other words, one or more of the ATA device 202, the server devices 204(1)-204(n), or the client devices 208(1)-208(n) may operate on the same physical device rather than as separate devices communicating through communication network(s) 210. Additionally, there may be more or fewer ATA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, Packet Data Networks (PDNs), the Internet, intranets, and combinations thereof.

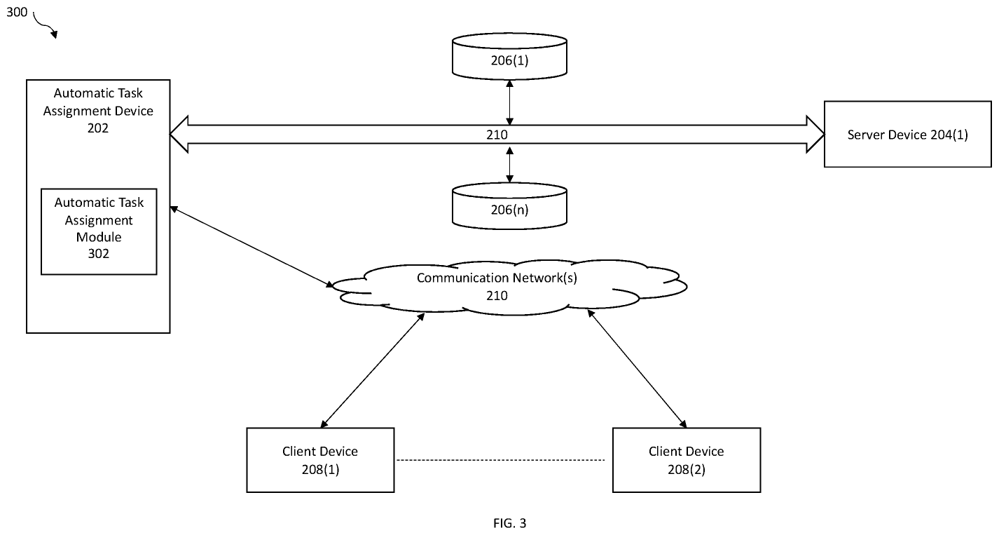

FIG. 3 illustrates an exemplary system for implementing a method for automatically assigning one or more tasks to one or more users, in accordance with an exemplary embodiment. As illustrated in FIG. 3, according to exemplary embodiments, the system 300 may comprise an ATA device 202 including an Automatic Task Assignment module 302 that may be connected to a server device 204(1) and one or more repository 206(1) . . . 206(n) via a communication network 210, but the disclosure is not limited thereto.

The ATA device 202 is described and shown in FIG. 3 as including an Automatic Task Assignment module 302, although it may include other rules, policies, modules, databases, or applications, for example. As will be described below, the Automatic Task Assignment module 302 is configured to implement a method for automatically assigning one or more tasks to one or more users.

An exemplary process 300 for implementing a mechanism for automatically assigning one or more tasks to one or more users by utilizing the network environment of FIG. 2 is shown as being executed in FIG. 3. Specifically, a first client device 208(1) and a second client device 208(2) are illustrated as being in communication with ATA device 202. In this regard, the first client device 208(1) and the second client device 208(2) may be “clients” (or “users”) of the ATA device 202 and are described herein as such. Nevertheless, it is to be known and understood that the first client device 208(1) and/or the second client device 208(2) need not necessarily be “clients” of the ATA device 202, or any entity described in association therewith herein. Any additional or alternative relationship may exist between either or both of the first client device 208(1) and the second client device 208(2) and the ATA device 202, or no relationship may exist.

Further, the ATA device 202 is illustrated as being able to access the one or more repositories 206(1) . . . 206(n). The Automatic Task Assignment module 302 may be configured to access these repositories/databases for implementing a method for automatic assignment of one or more tasks to one or more users.

The first client device 208(1) may be, for example, a personal computer (PC), a laptop, a smart phone or the like. Of course, the first client device 208(1) may be any additional device described herein. The second client device 208(2) may be, for example, a personal computer (PC), a laptop, a smart phone or the like. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ATA device 202 via broadband or cellular communication. Of course, these embodiments are merely exemplary and are not limiting or exhaustive.

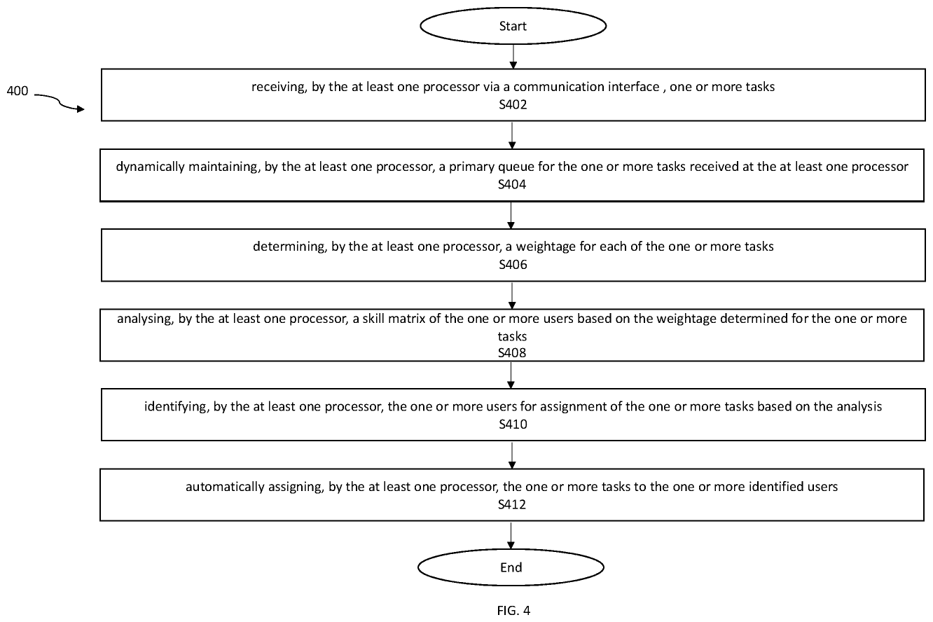

FIG. 4 illustrates a flowchart of an exemplary method [400] for implementing a method for automatically assigning one or more tasks to one or more users. As shown in FIG. 4, the method begins at step [S402] upon receiving, by the at least one processor via a communication unit, one or more tasks. In an exemplary embodiment of the present disclosure, the one or more tasks may relate to request for authentication of identity (e.g., a KYC request during onboarding of a new customer with a banking institution). The request for authentication of identity may be received (e.g. for a new customer or an existing customer) from a plurality of sources, including but not limited to, client devices of new customers, existing customers, other personnel or the like via a server.

At step [S404], the method as disclosed by the present disclosure comprises maintaining a dynamic primary queue for the one or more tasks received by the at least one processor. The one or more tasks, received by the at least one processor, are stacked in a queue (or a matrix or a list or the like) maintained by the at least one processor. In an exemplary embodiment of the present disclosure, the primary queue is also dynamically maintained to reflect an assignment status of the one or more tasks. The one or more tasks with the assignment status “unassigned” are further considered for assignment according to the method of the present disclosure.

At step [S406], the method as disclosed by the present disclosure comprises determining, via the at least one processor, a weightage for each of the one or more tasks. As disclosed by the present disclosure, the weightage is determined for each of the one or more tasks based on at least one of the following: an expected time for completion of the one or more tasks, an organisation type associated with the one or more tasks, an urgency associated with the one or more tasks, a type of request associated with the one or more tasks, and a due diligence condition associated with the one or more tasks. In an exemplary embodiment of the present disclosure, the expected time for completion, the organisation type, the urgency, the type of request, and the due diligence condition (regional or restricted due diligence) may be received as an input from the plurality of sources, or pre-programmed into the system or the apparatus. Further, in an exemplary embodiment of present disclosure, the weightage for each of the one or more tasks is automatically determined by the at least one processor implementing Artificial Intelligence and Machine Learning based on historical data pertaining to the one or more tasks.

At step [S408] of the method as disclosed by the present disclosure, the at least one processor analyses a skill matrix of the one or more users based on the weightage determined for the one or more tasks. The present disclosure encompasses that the skill matrix for the one or more users is pre-generated based on the one or more tasks assigned and/or completed by the one or more users in the part, say historical data. The present disclosure further encompasses that the skill matrix for the one or more users is pre-generated based on at least one of a number of the one or more tasks handled by the one or more users, a number of the tasks completed by the one or more users, a skill level of the one or more users, a region associated with the one or more tasks handled by the one or more users, a risk associated with the one or more tasks handled by the one or more users, and an organisation type associated with the one or more tasks handled by the one or more users. At step [S410] of the method as disclosed by the present disclosure, the at least one processor identifies the one or more users for assignment of the one or more tasks based on the analysis of the skill matrix. In an exemplary embodiment of the present disclosure, the at least one processor compares the weightage determined for the one or more tasks with the skill matrix for the one or more users. For instance, the at least one processor identifies the one or more users suitable for assignment of the one or more tasks, based on a high correlation value of the weightage compared with the skill matrix for the one or more users. It may be appreciated by a person skilled in the art that the at least one processor may adopt any efficient sequence of comparing the weightage of the one or more tasks with the skill matrix of the one or more user(s). In another instance, while analysing the skill matrix of the one or more users, the at least one processor, considers allocation the one or more tasks to that user(s) to which similar tasks were previously allocated, for faster execution of the task(s). In yet another exemplary embodiment of present disclosure, the skill matrix for the one or more users is automatically updated and maintained by the at least one processor implementing Artificial Intelligence and Machine Learning based on the historical data. Thereafter, at step [S412] of the method, the at least one processor automatically assigns one or more tasks to one or more identified users.

The present disclosure also encompasses that the at least one processor notifies the user of the allocation/assignment of one or more tasks. In an exemplary embodiment of the present disclosure, the one or more users may be notified of the allocation/assignment by way of an alert, email, message or the like. Upon assignment of the one or more tasks to the one or more users, the assignment status of the one or more tasks are may be changed to “assigned” in the primary queue.

The present disclosure also encompasses identifying the one or more users based on an availability of the one or more users for assigning of the task based on the availability of the one or more users. The present invention thus takes into account scenarios where the one or more users may not be available for reasons including scheduled vacation time, scheduled continuing education courses, meetings, projects, or other tasks. For example, for a modification (change) in the availability of the one or more users to which a task was assigned, the present disclosure encompasses that the status of such task is changed to “unassigned”. Based on the analysis of the skill matrix of the rest of the users, another user can be automatically identified for assigning that task. A second assignment is done based on the client's information, such as but not limited to the complexity of the work, the regulations of the industry, applicable deadlines, and amount of work, and the available employee's information, such as past experience, industrial experience, professional credentials, and expertise of the other user.

In an exemplary embodiment, the present disclosure encompasses calculating a threshold for each of the one or more users bases on the historical data and the skill matrix, the threshold representing number of tasks a user can attend to. The present disclosure further encompasses that the at least one processor identifies the one or more users for assignment of the one or more tasks based on the analysis of the skill matrix and the threshold. For instance, at least one processor does not identify that user for allocation of the tasks once a threshold is reached for that user.

In an exemplary embodiment of the present disclosure, the method comprises maintaining a secondary queue for each of the one or more users, where the secondary queue for each of the one or more users consists of the one or more tasks assigned to the one or more users. The at least one processor maintains a secondary queue for each of the one or more users, wherein the secondary queue for a user may also represent the order of the one or more tasks assigned to that user. In cases where the first identified user is unavailable, the present disclosure encompasses automatically identifying another user (second user) from the one or more users based on the analysis of the skill matrix. Accordingly, the one or more tasks are removed from the secondary queue of the first identified user, and assigned in the secondary queue for the second identified user.

The present disclosure also encompasses that the status of the one or more tasks may automatically be changed to “completed” on completion of the execution of the task by the user it is assigned to. In an exemplary embodiment, the one or more users may themselves also change the status of the one or more tasks to “completed” once the task has been completed. Thereafter, said completed one or more tasks is automatically removed from the secondary queue of the one or more users. The secondary queue may also maintains a record of the time taken by the one or more users to complete the one or more tasks, and may update the same in the skill matrix for that user. Further, in an exemplary implementation, the present disclosure encompasses that the secondary queue for one or more users can be modified manually by another user. For instance, a managerial user may also manually modify the one or more tasks allocated to one or more users, or modify the order of the one or more tasks allocated to the user, or reassign the task to another user or assign the task to two or more users parallelly.

In yet another exemplary embodiment, the present disclosure encompasses that the one or more tasks may also be automatically assigned to at least one first user and at least one second user, for instance to two or more users parallelly. For instance, tasks which are required to be executed by more than one user, the present disclosure encompasses that the task may be automatically assigned to more than one users. Example of such scenarios include a task with specific due diligence conditions that may require execution by several employees working on such requests. For instance, for the one or more tasks requiring due diligence for a region, the task(s) shall additionally be assigned to another user handling the due diligence aspect. Therefore, at least one processor will automatically assign the one or more tasks parallelly to at least one first user for execution and also to at least one second user for due diligence. Such task(s) with restrictive due diligence condition may be assigned to the users parallelly which work on the restrictive countries mandated by the due diligence condition associated with the region associated with the task. Further, the status of the one or more tasks assigned to the at least first user and the at least one second user will be changed to “completed” once the task has been completed by the at least one first user and the at least one second user.

Thus, by practicing and implementing the method and system as illustrated in the above discussion, a person skilled in the art would be able to obtain an efficient and effective method and system for automatically assigning/allocating task(s) to user(s) that will lead to efficient use and management of resources, including professionals and support staff and engagements, which is critical to the effective and efficient delivery of services and work products. Dynamically allocating the task(s) to the user(s) with adequate capability as provided in the present disclosure will thereby increase the overall efficiency, thus reducing cost to the user(s) as well as increasing performance of the system. The present disclosure also provides for adequate tracking of performance, expertise, credentials, experience, qualification, client or task familiarity, and other work-related information, which will help organisations to streamline the process for both managing the work as well as the workforce.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and/or “computer-readable storage medium” shall also include any storage medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A method for automatically assigning one or more tasks to one or more users, the method comprising:
receiving, by at least one processor via a communication interface, the one or more tasks.
dynamically maintaining, by the at least one processor, a primary queue for the one or more tasks received at the at least one processor;
determining, by the at least one processor, a weightage for each of the one or more tasks;
analysing, by the at least one processor, a skill matrix of the one or more users based on the weightage determined for the one or more tasks;
identifying, by the at least one processor, the one or more users for assignment of the one or more tasks based on the analysis; and
automatically assigning, by the at least one processor, the one or more tasks to the one or more identified users.

2. The method as claimed in claim 1, wherein:
the skill matrix for the one or more users is based on at least one of a number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type associated with the one or more tasks handled by the one or more users, and
the weightage is determined for each of the one or more tasks based on at least one of an expected time for completion of the one or more tasks, an organization type associated with the one or more tasks, an urgency associated with the one or more tasks, a type of request associated with the one or more tasks, and a due diligence condition associated with the one or more tasks.

3. The method as claimed in claim 2, wherein automatically assigning the one or more tasks to the one or more identified users further comprises assigning the one or more tasks to at least one first user and at least one second user based on the due diligence condition associated with the one or more tasks and the region handled by the at least one first user and the at least one second user.

4. The method as claimed in claim 1, the method further comprising identifying the one or more users based on an availability of the one or more users.

5. The method as claimed in claim 4, wherein modification in the availability of the one or more users, the method further comprising automatically identifying another user from the one or more users based on the analysis of the skill matrix of the one or more users.

6. The method as claimed in claim 1, the method further comprising maintaining a secondary queue for each of the one or more users, wherein the secondary queue for each of the one or more users comprises of the one or more tasks assigned to the one or more users.

7. The method as claimed claim 1, the method further comprising notifying the one or more users of the assignment of the one or more tasks to the one or more users.

8. The method as claimed in claim 1, the method further comprising identifying the one or more users based on a threshold of the one or more users, wherein the threshold of the one or more users is determined based on the skill matrix.

9. The method as claimed in claim 1, wherein the one or more tasks relate to request for authentication of identity.

10. A computing device for automatically assigning one or more tasks to one or more users, the computing device comprising:
a processor;
a memory; and
a communication interface coupled to each of the processor and the memory,
wherein the processor is configured to:
receive the one or more tasks;
dynamically maintain a primary queue for the one or more tasks;
determine a weightage for each of the one or more tasks;
analyse a skill matrix of the one or more users based on the weightage determined for the one or more tasks;
identify the one or more users for assignment of the one or more tasks based on the analysis; and
automatically assign the one or more tasks to the one or more identified users.

11. The computing device as claimed in claim 10, wherein:
the skill matrix for the one or more users is based on at least one of a number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type associated with the one or more tasks handled by the one or more users, and
the weightage for each of the one or more tasks is determined based on at least one of an expected time for completion of the one or more tasks, an organization type associated with the one or more tasks, an urgency associated with the one or more tasks, a type of request associated with the one or more, and a due diligence condition associated with the one or more tasks.

12. The computing device as claimed in claim 11, wherein the processor is further configured to automatically assign the one or more tasks to at least one first user and at least one second user based on the due diligence condition associated with the one or more tasks and the region handled by the at least one first user and the at least one second user.

13. The computing device as claimed in claim 10, wherein the processor is further configured to identify the one or more users based on an availability of the one or more users.

14. The computing device as claimed in claim 13, wherein modification in the availability of the one or more users, the processor is further configured to automatically identify another user from the one or more users based on the analysis of the skill matrix the one or more users.

15. The computing device as claimed in claim 10, wherein the processor is further configured to maintain a secondary queue for each of the one or more users, wherein the secondary queue for each of the one or more users comprises of the one or more tasks assigned to the one or more users.

16. The computing device as claimed in claim 10, wherein the processor is further configured to notify the one or more users of the assignment of the one or more tasks to the one or more users.

17. The computing device as claimed in claim 10, wherein the processor is further configured to identify the one or more users based on a threshold of the one or more users, wherein the threshold of the one or more users is determined based on the skill matrix.

18. The computing device as claimed in claim 10, wherein the one or more tasks relate to request for authentication of identity.

19. A non-transitory computer readable storage medium storing instructions for automatically assigning one or more tasks to one or more users, the storage medium comprising executable code which, when executed by a processor, causes the processor to:
receive the one or more tasks;
dynamically maintain a primary queue for the one or more tasks;
determine a weightage for each of the one or more tasks;
analyse a skill matrix of the one or more users based on the weightage determined for the one or more tasks;
identify the one or more users for assignment of the one or more tasks based on the analysis; and
automatically assign the one or more tasks to the one or more identified users.

20. The non-transitory computer readable storage medium according to claim 19, wherein:
the skill matrix for the one or more users is based on at least one of a number of the one or more tasks handled by the one or more users, a time taken by the one or more users to complete the one or more tasks, a skill level of the one or more users, a region associated with the one or more tasks handled by the one or more users, a risk associated with the one or more tasks handled by the one or more users and an organization type associated with the one or more tasks handled by the one or more users, and
the weightage is determined for each of the one or more tasks based on at least one of an expected time for completion of the one or more tasks, an organization type associated with the one or more tasks, an urgency associated with the one or more tasks, a type of request associated with the one or more tasks, and a due diligence condition associated with the one or more tasks.
